(19) United States
(12) Patent Application Publication
(10) Pub. No.: US 2007/0274093 A1
(43) Pub. Date: Nov. 29, 2007

(54) LED backlight system for LCD displays

(75) Inventors: Victoria P. Haim, Glendale, AZ (US); Elias S. Haim, Glendale, AZ (US); Brent D. Larson, Cave Creek, AZ (US); Dennis M. Davey, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/440,487

(22) Filed: May 25, 2006

(51) Int. Cl. F21V 7/04

(52) U.S. Cl. 362/561

(57) ABSTRACT

A LCD display comprises a backlight assembly that includes a backlight substrate, one or more first white LEDs coupled to the backlight substrate and configured to produce a first light output, and one or more second white LEDs coupled to the backlight substrate and configured to produce a second light output. A light integration unit is coupled to the backlight assembly and configured to produce a combined output from the first light output and the second light output, the combined output having a desired luminance and chrominance. A LCD assembly is coupled to the light integration unit.

### FIELD OF THE INVENTION

The present invention relates to the field of LCD displays, and more particularly, to a LED backlight system for LCD displays.

### BACKGROUND OF THE INVENTION

Backlights are used in transmissive displays, such as liquid crystal displays (LCDs), to enhance user visibility under various conditions. The most common type of backlights for LCDs are fluorescent lamp backlights. Fluorescent lamp backlights, while effective in many applications, generally have a relatively high driving voltage. Additionally, it is difficult to provide dimming (i.e., variable luminance) and color alteration (i.e., variable chrominance) capabilities in fluorescent backlights. Also, compact fluorescent lamps are relatively fragile and the use of compact fluorescent lamps in backlight applications where mechanical ruggedness is important, such as avionics applications, can be problematic.

Light emitting diode (LED) backlights have been developed in order to provide a backlight that overcomes, at least in part, the drawbacks of fluorescent lamp backlights. In a typical LED backlight, LEDs are placed behind an LCD display. One type of LED backlight that is placed behind an LCD display uses white LEDs.

White LEDs are typically formed of LEDs which produce a short wavelength blue light that have a phosphor or similar coating that converts part of the blue light to a light spectrum centered about yellow light. The combination of the blue light from the LED and the yellow light from the phosphor coating gives the appearance of white light to a user. While blue LEDs with phosphor coating can be used to produce white lights, other combinations of violet, ultraviolet, or other short wavelength light in combination with a phosphor coating can also be used to produce white light.

The actual appearance of the white light can vary depending on the color temperature of the white light. Color temperature is a metric that characterizes the spectral weighting of power in a light distribution, especially white light, stated in terms of the Kelvin temperature scale. The concept of color temperature is based on the observation that a substance heated to high temperatures emits visible radiation in a broad spectrum. At 2000° K., the emitted light looks orange-yellow, based on the high proportion of long “warm” wavelengths. As the temperature increases to 20,000° K., the white light appears blue, based on the high proportion of short “cool” wavelengths. Between these two extremes, the light appears to be “white” rather than yellow or blue, although the “white” light will range from warm to cool, depending on such factors as intensity and context.

By altering the chemical composition of the phosphor, the color temperature of the white LEDs can be varied from a warm white LED (i.e., white light having a yellowish or reddish tint) to a cool white LED (i.e., white light having a bluish tint). Color temperature describes the hue of the white light by comparison to a theoretical black body radiator. One drawback of a white LED backlight is if the backlight only includes warm LEDs, more power is utilized to operate the backlight because warm LEDs are generally less efficient than cool LEDs. However, one drawback of backlight systems that are limited to cool LEDs is less than optimal performance at displaying the color red because cool LEDs have comparatively less energy in the red region of the visible spectrum.

Accordingly, it is desired to provide an improved backlight, backlight display and method of operating a backlight display system, especially apparatus and methods that utilize white LEDs adjustable to include variable chrominance and luminance. Furthermore, the desirable features and characteristics of the present invention will be apparent from the subsequent detailed description and the appended claims, taken in conjunction with the accompanying drawings and the foregoing technical field and background.

### BRIEF SUMMARY OF THE INVENTION

In one embodiment of the present invention, a backlight assembly for a LCD panel comprises a backlight substrate. One or more first white LEDs are coupled to the backlight substrate and configured to produce a first light output. One or more second white LEDs are coupled to the backlight substrate and configured to produce a second light output. The first light output and the second light output optically mix to produce a combined backlight output having a desired luminance and chrominance.

In another embodiment, a LCD assembly comprises a backlight assembly comprising a backlight substrate, a plurality of first white LEDs coupled to the backlight substrate and configured to produce a first light output, and a plurality of second white LEDs coupled to the backlight substrate and configured to produce a second light output. A light integration unit is coupled to the backlight assembly and configured to produce a combined output from the first light output and the second light output, the combined output having a desired luminance and chrominance. A LCD assembly is coupled to the light integration unit.

In another embodiment, a method for illuminating a LCD panel comprises generating a first output from first white LEDs and generating a second output from second white LEDs. Then, the first output and the second output are optically mixed to produce a combined output having a desired chrominance and luminance.

### BRIEF DESCRIPTION OF THE DRAWINGS

The present invention will hereinafter be described in conjunction with the following drawing figures, wherein like numerals denote like elements, and:

FIG. 1 is a cross-sectional view of an exemplary backlit LCD display in accordance with an exemplary embodiment of the present invention;

FIG. 2 is a schematic view of a backlight in accordance with an exemplary embodiment of the present invention;

FIG. 3 is a side view of an exemplary embodiment of a backlit display having edge illumination in accordance with an exemplary embodiment of the present invention; and

FIG. 4 is a side view of an exemplary embodiment of a backlit display having direct view illumination and edge illumination in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

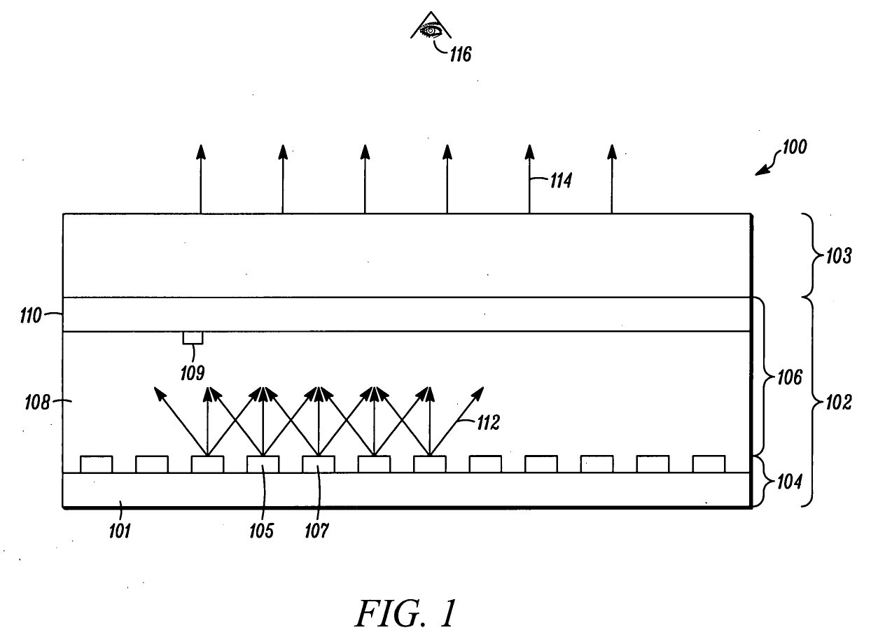

FIG. 1 is a simplified cross-sectional view of an exemplary embodiment of a backlit LCD display 100, for use, for example, as an avionics display. Backlit LCD display 100 comprises a backlight assembly 102 coupled to a LCD assembly 103. Backlight assembly 102 comprises a direct backlight 104 coupled to a light integration unit 106. In the exemplary embodiment of FIG. 1, the direct backlight 104 is known as a direct view illumination system because the illumination is provided directly behind the LCD assembly 103.

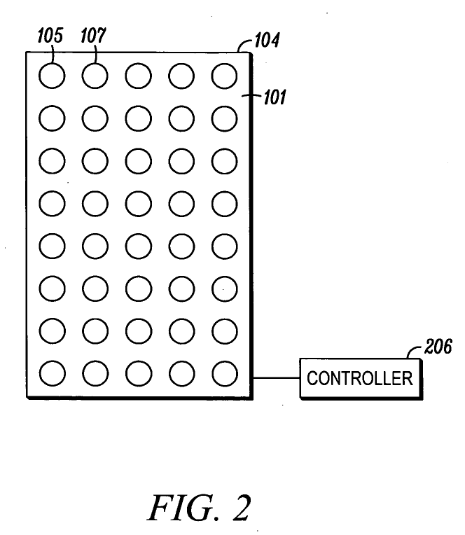

Direct backlight 104 comprises first white LEDs 105 having a first color temperature and second white LEDs 107 having a second color temperature other than the first white LEDs 105. The first white LEDs 105 and second white LEDs 107 are mounted on a substrate 101 and the direct backlight 104 is coupled to a controller 206. As illustrated in FIG. 2, which is a simplified view of the direct backlight 104 in accordance with an exemplary embodiment of the present invention, direct backlight 104 is comprised of N rows and M columns of LEDs for a total of N×M LEDs. The number of rows and columns of LEDs in a given backlight, such as direct backlight 104, can be chosen based on such factors as the size of the LCD display 100 and the desired intensity. At a minimum, at least one of the first LED and one of the second LED are needed for a practical backlight. Additionally, the LEDs can be arranged in any pattern that provides a desired amount of illumination. Backlight substrate 101 can be a single substrate or can comprise multiple sections each supporting one or more LEDs.

First white LEDs 105 and second white LEDs 107 can be any LEDs that produce a white light and have different color temperatures. In one exemplary embodiment, first white LEDs 105 and second white LEDs 107 are phosphor coated blue LEDs that produce a visible white light having different color temperatures. For example, in this exemplary embodiment, the first white LEDs 105 produce a white light that is more blue in color (i.e., a cooler white) while the second white LEDs 107 produce a white light that is more yellow in color (i.e., a warmer white). White LEDs are available commercially from a number of commercial vendors. White LEDs manufactured using other methods can also be used.

As discussed previously, using white LEDs having a single color temperature (for example, a single design and type of phosphor coating) for the direct backlight 104 has inherent drawbacks, such as lacking the ability to adjust the chrominance of the direct backlight 104. However, mixing the optical output of the first white LEDs 105 and the optical output of the second white LEDs 107, when used in conjunction with the LCD assembly 103, produces an adjustable combined optical output having an adjustable chrominance and luminance. By using different types of white LEDs, as opposed to different colored LEDs, compensating for the aging of the LEDs is simplified since white LEDs, regardless of the color temperature, should age similarly.

More specifically, controller 206 is configured to adjust the amount of current provided to the first white LEDs 105 and the second white LEDs 107. Adjusting the current through the first white LEDs 105 and the second white LEDs 107 alters the intensity of the light produced by the first white LEDs 105 and the second white LEDs 107. Thus, controller 206 can be used to adjust the brightness of the LCD display 100 by changing the current through all of the LEDs. Additionally, the controller 206 can be used to adjust the brightness of the LEDs as the LEDs or other system components age over time.

In one exemplary embodiment of the present invention, controller 206 is configured such that the current through the first white LEDs 105 can be varied independently from the current through the second white LEDs 107. By separately varying the intensity of the output of the first white LEDs 105 and the output of the second white LEDs 107, a mixture of light can be produced having a combined optical output that has a desired luminance (i.e., intensity) and chrominance (i.e., color). That is, a desired color temperature for the overall optical output of the backlight 104 can be achieved by mixing the output of the first white LEDs 105 having a particular color temperature with the output of the second white LEDs 107 having a particular color temperature. Varying the intensity of the first white LEDs 105 and the second white LEDs 107 varies the amount of light of each particular color temperature contributed by the first white LEDs 105 and the second white LEDs 107 to the overall combined optical output.

In another exemplary embodiment, current through the first white LEDs 105 and the second white LEDs 107 can be controlled together. In this embodiment, the ratio of the number of first white LEDs 105 to the number of second white LEDs 107 can be chosen to provide a desired luminance and chrominance when used in conjunction with the LCD assembly 103.

In one exemplary embodiment, first white LEDs 105 are selected to have a color temperature in the range of 20,000 to 5,000 Kelvin, and preferably in the range of 8000 to 6000 Kelvin. The second white LEDs 107 are selected to have a color temperature in the range of 5,000 to 2,000 Kelvin, and preferably in the range of 4000 to 3000 Kelvin. In this exemplary embodiment, the backlight produces an optical output of a white light having a color temperature adjustable between the selected first and second color temperatures, for example, in the range of 10,000 to 4,000 Kelvin, and preferably in the range of 5000 to 4000 Kelvin. These ranges are for exemplary purposes only and it is understood other ranges of color temperatures can be selected based on factors such as LCD performance, component availability, customer preferences, and other design constraints.

While FIG. 1 illustrates an exemplary embodiment using two white LEDs having different color temperatures, additional white LEDs having color temperatures different from the first white LEDs 105 and the second white LEDs 107 can be used. In another exemplary embodiment, one or more non-white LEDs can be used in conjunction with the first white LEDs 105 and the second white LEDs 107 to provide enhancement to the chrominance of the backlight.

Light integration unit 106 preferably comprises a backlight cavity 108 coupled to a diffuser 110. Backlight cavity 108 provides an area for the light rays 112 from the first white LEDs 105 and the second white LEDs 107 to optically mix an optimal sum of the light rays 112. The diffuser 110 statistically redirects the mixed light rays 112 and preferably distributes the mixed light rays 112 with substantial uniformity. Backlight cavity 108 further comprises a light sensor 109 that can determine the intensity and relative color of light rays 112. The sensor 109 can be coupled to the controller 206 in order for the controller 206 to receive feedback data to determine the current adjustments through the LEDs to adjust a combined optical output of the LEDs to achieve a desired luminance, chrominance and/or luminance and chrominance. This can be done, for example, to compensate for a dimming backlight caused by aging of the LEDs and the like.

LCD assembly 103 comprises, in one exemplary embodiment, many pixels addressable by an active matrix of thin film transistors (TFTs) that cause the liquid crystal material above the addressing structure to locally change the polarization of light passing through the liquid crystal material based on received electronic signals. The light passing through the LCD assembly 103, as well as any color filters (not shown), is either emitted or inhibited, depending on the polarization state of light exciting the front surface of the LCD display 100, forming an image 114 viewable by a user 116. Other types of light modulating devices may alternatively be used, such as passive matrix LCDs, segmented displays, patterned indicator panels or directly driven LCDs as are well known in the art.

In the present invention, the combined optical output of the direct backlight 104 can be matched to the characteristics of the LCD assembly 103 to produce a LCD display, such as LCD display 100 that has a desired color output and intensity. One advantage of adjusting the output of the direct backlight 104 is that the direct backlight 104 can be matched to a-commercially available LED assembly 103 to satisfy a user requirement for desired chrominance and luminance. Another advantage of the use of first white LEDs 105 and second white LEDs 107 is that since the LEDs are of a similar color (both a type of white LED) uniform mixing is achieved easier.

As discussed previously, the LCD display 100 can be used in an aircraft as an avionics display, such as a multifunction display unit (MFDU). In this embodiment, the desired optical output in terms of luminance and chrominance is selected such that the symbology on the display can be enhanced. For example, the optical output of the LCD display can be selected to enhance the recognition and readability of symbology displayed on an avionics display, such as warning symbols.

As discussed previously, in one embodiment, the ratio of the first white LEDs 105 and the second white LEDs 107 can be selected to form the LCD display 100 with the desired chrominance and luminance. In another embodiment, the output of the first white LEDs 105 and the output of the second white LEDs 107 can be adjusted by adjusting the current through the first white LEDs 105 and the second white LEDs 107 to provide a LCD display 100 having a desired chrominance and luminance.

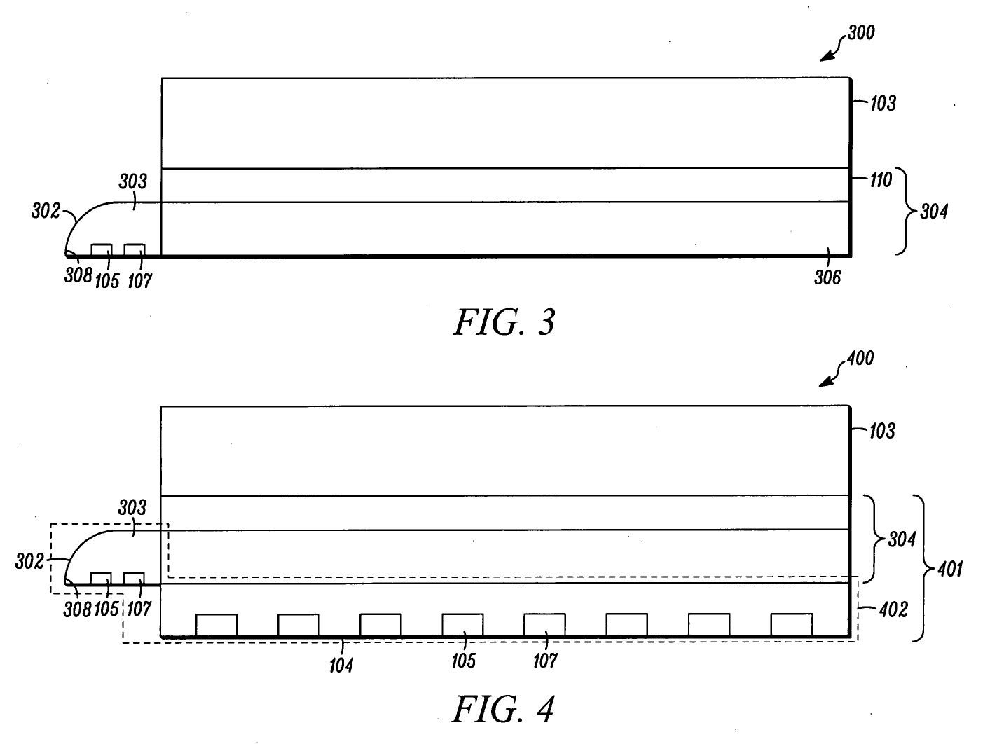

FIG. 3 illustrates an alternative exemplary embodiment of the LCD display 300 with edge illumination. LCD display 300 comprises an edge illumination assembly 302 coupled to a light integrator 304 comprising a light guide 306 and a diffuser 110, which is coupled to LCD assembly 103. Edge illumination assembly 302 provides illumination to the light integrator 304. In an exemplary embodiment, edge illumination assembly 302 comprises the first white LEDs 105 and the second white LEDs 107. While only two LEDs are shown in the cross-sectional view of FIG. 3, any number of LEDs necessary for proper edge illumination can be used. Edge illumination assembly 302 also includes a light mixing cavity 303 where the output of the first white LEDs 105 and the second white LEDs 107 can be optically mixed. Edge illumination assembly 302 also includes a reflector 308, which can be any material that can reflect the output of the first white LEDs 105 and the second white LEDs 107 into the light guide 306.

Light guide 306 provides a medium through which the light output of edge illumination assembly 302 can further mix. The light can then exit through apertures or via other light extraction features (not shown) found at locations on or around the light guide 306. The output of the light guide 306 is then distributed by diffuser 110. In one exemplary embodiment, a mixing cavity can be included as part of the light integrator 304 to allow for additional mixing of the output of the first white LEDs 105 and the second white LEDs 107.

The LCD assembly 103 operates in a conventional manner, and receives the light from the edge illumination assembly 302. As discussed previously, either the ratio of the first white LEDS 105 to the second white LEDs 107 can be selected to achieve a desired luminance and chrominance or the optical output of the first white LEDs 105 and the optical output of the second white LEDs 107 can be adjusted to achieve desired luminance and chrominance for the LCD assembly 103.

In an alternative embodiment, edge illumination assembly 302 can comprise at least two separate edge illuminations, one of which includes the first white LEDs 105 and one of which includes the second white LEDs 107. Each edge illumination assembly 302 can be coupled to a light guide 306 and the edge illumination assemblies 302 can be stacked upon each other. In another embodiment, each edge illumination assembly 302 can be coupled to its own corresponding light guide 306, and the plurality of light guides 306 can be stacked upon each other.

FIG. 4 illustrates another exemplary embodiment of an LCD display 400 having both edge illumination and direct view illumination. The LCD display 400 includes a LCD assembly 103 coupled to a backlight assembly 401. Backlight assembly 401 comprises a backlight 402 coupled to a light integrator 304.

Backlight 402 includes the edge illumination assembly 302, as first discussed in conjunction with FIG. 3, and the direct backlight 104 for direct view illumination, first discussed in conjunction with FIG. 1, to provide illumination to the LCD display 400. The edge illumination assembly 302 and the direct backlight 104 can both include the first white LEDs 105 and the second white LEDs 107. Alternatively, the edge illumination assembly 302 can include the first white LEDs 105 and the direct backlight 104 can include the second white LEDs 107 or vice versa. Indeed, any combination of the first white LEDs 105 and the second white LEDs 107 that provides proper illumination can be distributed between the edge illumination assembly 302 and the direct backlight 104.

In one embodiment, both the edge illumination assembly 302 and the direct backlight 104 can be coupled to light guide 306. In another embodiment, the direct backlight 104 can be coupled to the light guide 306 via an intervening backlight cavity. The size of the backlight cavity can be varied by varying the separation between the direct backlight 104 and the light guide 306. The output of the light guide 306 can be coupled to the diffuser 110 for diffusing the light from the light guide 306. The diffused light is provided to the LCD assembly 103 which produces a backlit image as discussed previously.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A backlight assembly for a LCD display comprising:
one or more first white LEDs having a first color temperature and producing a first light output;
one or more second white LEDs having a second color temperature other than the first color temperature and producing a second light output;
a backlight substrate coupled to the one or more first white LEDs and the one or more second white LEDs; and
wherein the first light output and the second light output optically mix to produce a combined backlight output having a desired luminance and chrominance.

2. The backlight assembly of claim 1 wherein the ratio of the one or more first white LEDs to the one or more second white LEDs is selected to produce a combined backlight output having a desired luminance and chrominance.

3. The backlight assembly of claim 1 wherein an intensity of the one or more first white LEDs and the one or more second white LEDs are adjusted to produce a combined backlight output having a desired luminance and chrominance.

4. The backlight assembly of claim 1 further comprising a controller coupled to the one or more first white LEDs and the one or more second white LEDs, the controller configured to vary a first current through the one or more first white LEDs independently of a second current through the one or more second white LEDs.

5. The backlight assembly of claim 4 wherein the first current and the second current can be varied to vary the first light output and the second light output to produce a combined backlight output having a desired luminance and chrominance.

6. The backlight assembly of claim 1 wherein the backlight substrate includes part of an edge illumination unit.

7. The backlight assembly of claim 1 wherein the backlight substrate includes part of a direct view illumination unit.

8. The backlight assembly of claim 1 wherein the desired luminance and chrominance is selected to enhance the readability of symbology in an avionics display.

9. A LCD display comprising:
a backlight assembly comprising:
a plurality of first white LEDs coupled to a backlight substrate and configured to produce a first light output comprising a first color temperature; and
a plurality of second white LEDs coupled to the backlight substrate and configured to produce a second light output comprising a second color temperature;
a light integration unit coupled to the backlight assembly and configured to produce a combined output from the first light output and the second light output; and
a LCD assembly coupled to the light integration unit.

10. The LCD display of claim 9 wherein the ratio of the plurality of the first white LEDs to the plurality of second white LEDs is selected to produce the combined output having a desired luminance and chrominance.

11. The LCD display of claim 9 wherein an intensity of the plurality of the first white LEDs and the plurality of the second white LEDs are adjusted to produce the combined output having a desired luminance and chrominance.

12. The LCD display of claim 9 further comprising a controller coupled to the plurality of the first white LEDs and the plurality of the second white LEDs, the controller configured to vary a first current through the first white LEDs independently of a second current through the plurality of the second white LEDs.

13. The LCD display of claim 9 wherein the backlight assembly is part of an edge illumination unit.

14. The LCD display of claim 9 wherein the backlight assembly is a direct view illumination unit.

15. The LCD display of claim 9 further comprising a sensor mounted in the light integration unit, the sensor configured to send data to the controller to provide adjustment of a combined optical output of the plurality of first white LEDs and the plurality of second white LEDs.

16. The LCD display of claim 9 wherein the light integration unit comprises an illumination cavity and a diffuser.

17. The LCD display of claim 9 wherein the first color temperature is in the range of 20,000 to 5,000 Kelvin and the second color temperature is in the range of 5,000 to 2,000 Kelvin to produce a combined output in the range of 10,000 to 4,000 Kelvin.

18. The LCD display of claim 9 wherein the backlight assembly is part of an edge illumination unit and a direct view illumination unit.

19. A method for illuminating a LCD display comprising:
generating a first output from a first white LED, the first output having a color temperature;
generating a second output from a second white LED, the second output having a color temperature that is different than the color temperature of the first output;
optically mixing the first output and the second output in a backlight cavity to produce a combined output having a desired chrominance and luminance; and
directing the combined output through an LCD assembly.

20. The method of claim 19 wherein the step of generating a first output from a first white LED further comprises providing a first current through the first white LED to produce the first output and wherein the step of generating a second output from a second white LED further comprises providing a second current through the second white LED to produce the second output.
